(19) United States
(12) Patent Application Publication
(10) Pub. No.: US 2022/0047360 A1
(43) Pub. Date: Feb. 17, 2022

(54) IMPLANT STRUCTURE

(71) Applicant: Myung Heon HA, Osan-si Gyeonggi-do (KR)

(72) Inventor: Myung Heon HA, Osan-si Gyeonggi-do (KR)

(21) Appl. No.: 17/274,759

(22) PCT Filed: Jun. 13, 2019
(86) PCT No.: PCT/KR2019/007215

§ 371 Date: Mar. 9, 2021

(30) Foreign Application Priority Data
Sep. 10, 2018 (KR) 10-2018-0107560
Apr. 2, 2019 (KR) 10-2019-0038255

(51) Int. Cl. A61C 8/00; A61C 13/277

(52) U.S. Cl. CPC A61C 8/0095; A61C 13/277; A61C 8/0062; A61C 8/0069

(57) ABSTRACT

Disclosed is an implant structure. The implant structure of an embodiment of the present invention comprises: a retainer for forming a cap of a denture structure; a fixing portion which is implanted in the gum and is provided with a fixture at a lower portion thereof, the fixture being implanted and fixed in the alveolar bone, and an abutment at an upper portion thereof, the abutment connecting the fixture to the retainer, wherein the abutment is integrally formed with the fixture; and a coil spring formed in a ring shape to provide elastic force to the retainer and the abutment, wherein a seating portion on which the spring is seated is formed inside the retainer.

### CROSS-REFERENCE TO RELATED APPLICATION

This application is a 35 U.S.C. 371 National Phase Entry application from PCT/KR2019/007215, filed Jun. 14, 2019, designating the United States, which claims priority to and the benefit of Korean Patent Application Nos. 10-2018-0107560, filed on Sep. 10, 2018, and 10-2019-0038255, filed on Apr. 2, 2019, the disclosures of which are incorporated herein by reference in its entirety.

### TECHNICAL FIELD

The present invention relates to an implant structure.

### BACKGROUND

In general, an implant is an aspect of an artificial tooth and is an artificial prosthesis that restores functions such as mastication, aesthetics, and pronunciation. After implantation is completed, implants have an appearance and function that are difficult to distinguish from natural teeth, and their lifespan is also semi-permanent depending on the state of management, so they are widely used.

Such an implant may largely include a fixture, an abutment and a retainer.

The fixture is a part that is implanted and fixed in an alveolar bone, the retainer is a part that fixes a denture structure by combining with the denture structure, and the abutment is a part that connects the fixture and the retainer.

Specifically, a conventional implant has a structure in which the lower side of the abutment is screwed to or integrally configured with the fixture, and the retainer is fixed to the upper side with an adhesive.

However, there are some problems that it is difficult to remove the retainer from the abutment as the retainer is fixed to the upper portion of the abutment with an adhesive, and it is difficult to precisely position it in the user' mouth since the angle formed by the tooth attached to the upper portion of the retainer with the retainer is fixed.

The above information disclosed in this Background section is only for enhancement of understanding of the background of the invention and it may therefore contain information that does not form the prior art that is already known to a person of ordinary skill in the art.

### SUMMARY

The present invention is directed to providing an implant structure that is stably fixed with a spring interposed between an abutment and a retainer, and is easy to attach and detach, and having different angles according to the position of the tooth to be attached.

An implant structure according to an embodiment of the present invention may include a retainer fixing a denture structure by combining with the denture structure; a fixing portion comprising a fixture implanted in an alveolar bone of a gum, and an abutment at an upper portion of the fixture, the abutment connecting the fixture to the retainer, wherein the abutment is integrally formed with the fixture; and a coil spring to provide elastic force to the retainer and the abutment, wherein a seating portion on which the spring is seated is formed inside the retainer.

In an embodiment of the present invention, a first protrusion portion may be formed on an upper portion of the abutment so that an inner side of the spring is in contact with the abutment at a lower portion of the first protrusion portion.

In an embodiment of the present invention, a recess portion in which the spring is seated may be formed at an upper portion of the abutment, and an outer side of the spring may be in contact with an inner side surface of the retainer.

In an embodiment of the present invention, the abutment may include a contact portion with which the spring is in contact; a second protrusion portion protruding outwards from the first contact portion at an upper portion of the first contact portion; and a third protrusion portion protruding outwards from the second contact portion at a lower portion of the first contact portion, wherein the inner side of the spring is in contact with the first contact portion, the second protrusion portion, and the third protrusion portion.

In an embodiment of the present invention, a cross section of the spring may be greater than a length of the first contact portion and may be seated on the seating portion.

In an embodiment of the present invention, the spring may be seated in a recess portion formed by the contact portion, the second protrusion portion, and the third protrusion portion.

In an embodiment of the present invention, the abutment may include an upper portion rotatably formed in a spherical shape; a lower portion connecting the upper portion to a body of the fixing portion; and a bent portion in which the spring is disposed between the upper portion and the lower portion, wherein the inner side of the spring may be in contact with the bent portion.

In an embodiment of the present invention, the retainer may have a hollow cylindrical shape, and a portion of the upper portion may protrude outwards from the retainer.

In an embodiment of the present invention, the base material of the spring may include any one or more of copper alloys, stainless steel alloys or titanium, and may be surface-treated.

In an embodiment of the present invention, the spring may be a canted coil and exhibit deflection characteristics under pressure.

The present invention has an effect that as a spring is interposed between the retainer and the abutment, due to the elastic force of the spring the retainer may be stably coupled to the abutment and at the same time be easily dropped out therefrom.

In addition, it has an effect that since different angles may be configured according to the position of the attached teeth due to the deflectable spring, it prevents a feeling of foreign objects on the attached teeth.

### BRIEF DESCRIPTION OF THE DRAWINGS

The above and other aspects, features, and advantages of the present invention will become more apparent to those of ordinary skill in the art by describing embodiments thereof in detail with reference to the accompanying drawings, in which:

FIG. 1A is an exemplary view for explaining the configuration of an implant structure according to an exemplary embodiment of the present invention.

FIG. 1B is an exemplary view for explaining the degree of deflection of a spring of FIG. 1a.

FIGS. 2A to 10B are exemplary views for explaining the configuration of an implant structure of another embodiment of the present invention, respectively.

### DETAILED DESCRIPTION OF THE EMBODIMENTS

Hereinafter, in order to fully understand the configuration and effects of the present invention, preferred embodiments of the present invention will be described with reference to the accompanying drawings. However, the present invention is not limited to the embodiments disclosed below, and may be embodied in various forms and various modifications may be made. Rather, the description of the present invention is provided so that this disclosure will be thorough and complete and will fully convey the concept of the invention to those of ordinary skill in the art. In the accompanying drawings, the size of the elements is enlarged compared to actual ones for the convenience of description, and the ratio of each element may be exaggerated or reduced.

Terms such as ‘first’ and ‘second’ may be used to describe various elements, but, the above elements should not be limited by the terms above. The terms may only be used to differentiate one element from another. For example, without departing from the scope of the present invention, ‘first element’ may be named ‘second element’ and similarly, ‘second element’ may also be named ‘first element.’ In addition, expressions in the singular include plural expressions unless explicitly expressed differently in context. Unless otherwise defined, the terminology used in the embodiments of the present invention may be interpreted as meanings commonly known to those of ordinary skill in the art.

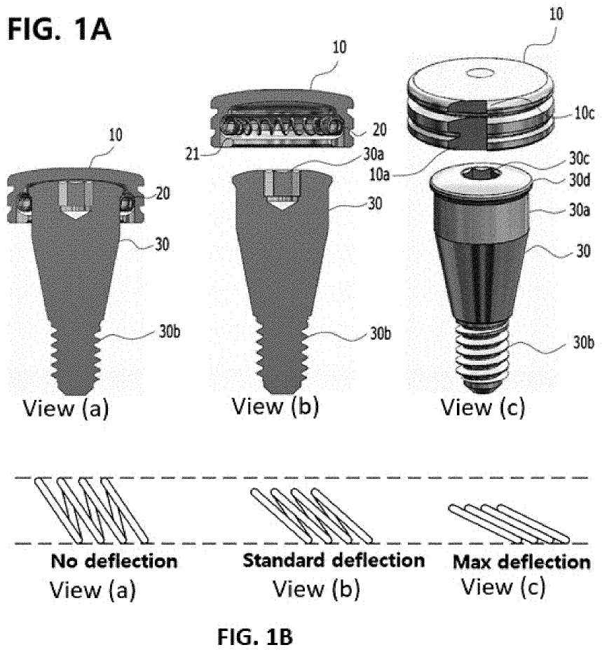

Hereinafter, an implant structure according to an embodiment of the present invention will be described with reference to FIGS. 1A to 10B.

FIG. 1A is an exemplary view for explaining the configuration of an implant structure according to an exemplary embodiment of the present invention in which View (a) is a sectional view, View (b) is a sectional view in which a retainer is separated from a fixing portion, and View (c) is an exploded perspective view.

Referring to the above drawings, an implant structure according to an embodiment of the present invention includes a retainer 10, a spring 20 disposed inside the retainer 10, and a fixing portion 30 that is implanted in an alveolar bone and coupled to the retainer 10.

In an embodiment of the present invention, a denture structure is fixed to a gum by the retainer 10, and the denture structure is fitted to the outside of the retainer 10 to be fixed. In this case, the retainer 10 may be inserted inside the denture structure. Hereinafter, this may be the same in the description of each embodiment, and a description thereof will be omitted since it is redundant.

The fixing portion 30 may include an abutment 30a at an upper portion thereof and a fixture 30b at a lower portion thereof. In an embodiment of the present invention, the abutment 30a and the fixture 30b may be integrally configured. A protrusion portion 30d may be formed on the upper portion of the abutment 30a, and the lower portion thereof may be in contact with the inner side of the spring 20.

A hexagonal tool insertion groove 30c to which the tool is fastened when the fixing portion 30 is implanted may be formed on the upper portion of the abutment 30a. However, the tool insertion groove 30c of the present invention is not limited to a hexagonal shape, and a circular or polygonal tool insertion groove 30c may be formed according to the shape of the tool to be fastened.

The retainer 10 may be formed to have a seating portion 10a on which the spring 20 is seated therein so that the upper surface of the seating portion 10a of the retainer 10 and the upper surface of the abutment 30a may contact each other.

The outer surface of the retainer 10 may have an uneven portion 10c outside to facilitate removal of a tooth-shaped crown, and a cut portion formed on one side so that an operator can easily rotate the retainer 10.

The spring 20 is a canted ring-shaped coil spring, and may be configured to attenuate shock or vibration to absorb shock or vibration applied to the retainer 10 and the fixing portion 30. The spring 20 according to an embodiment of the present invention may provide improved contact performance and a longer lifespan. The spring 20 may be independently deflected to compensate for contact and surface fluctuations, thereby allowing tolerances between mating parts.

FIG. 1B is an exemplary view for explaining the degree of deflection of the spring 20 in which View (a) is a case where there is no deflection, View (b) is a case of a standard deflection, and View (c) is a case of a maximum deflection.

As shown in the drawings, the spring 20 according to an embodiment of the present invention may be a canted coil and exhibit deflection characteristics under pressure. Each angled coil may create a radial or axial force for a uniform load around the entire spring radius. In this case, the pressure may be about 1N to 50N, and a change in angle may represent a movement of 1 to 40 degrees. However, this pressure corresponds to a case where one implant structure of an embodiment of the present invention is used, and if two or more implant structures are used to fix the denture structure are used, the pressure may increase.

The spring 20 of an embodiment of the present invention is deformed as shown in Views (a) to (c) of FIG. 1B due to change of the deflection according to the contact between the retainer 10 and the abutment 30a, thereby capable of responding efficiently to changes in pressure, and also responding efficiently to changes in tolerance.

In an embodiment of the present invention, the base material of the spring 20 may include any one or more of various copper alloys, stainless steel alloys or titanium, and may be surface-treated.

In an embodiment of the present invention, the cross section of the coil of the spring 20 is shown as circular, but it is not limited thereto, and a deflected spring having a different angle at which the denture structure is laid may be selected according to the position of the patient's tooth, and the spacing of the protrusion portions 30d may be determined by this spring. Alternatively, the cross section may be deformed into an elliptical shape due to the occurrence of deflection according to the distance between the seating portion 10a of the retainer 10 and the protrusion portion 30d of the abutment 30a.

The spring 20 is disposed on the seating portion 10a of the retainer 10, and the protrusion portion 30d of the abutment 30a may be configured to be disposed on the upper portion of the spring 20. In this configuration, the spring 20 may provide an elastic force to the retainer 10 and the abutment 30a, whereby it may be configured that the retainer 10 may be stably coupled to the abutment 30a and at the same time be easily dropped out therefrom. In addition, since different angles may be configured according to the position of the attached teeth due to the deflectable spring 20, it may be possible to prevent a feeling of foreign objects on the attached teeth.

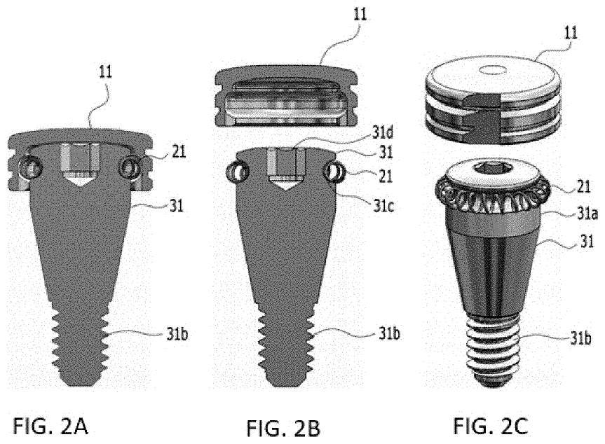

FIGS. 2A-2C are an exemplary view for explaining the configuration of an implant structure according to another embodiment of the present invention in which FIG. 2A is a sectional view, FIG. 2B is a sectional view in which a retainer is separated from a fixing portion, and FIG. 2C is an exploded perspective view. Description of the same configuration as in FIG. 1A will be omitted.

Referring to the above drawings, an implant structure according to an embodiment of the present invention includes a retainer 11, a spring 21 and a fixing portion 31 that is implanted in an alveolar bone and coupled to the retainer 11.

The fixing portion 31 may be formed by integrally forming an upper abutment 31a and a lower fixture 31b, wherein a recess portion 31c having a recess shape in which the spring 21 is seated may be formed on the abutment 31a.

In an embodiment of the present invention, the upper surface of the abutment 31a and the upper surface of the inner side of the retainer 11 may be configured to contact each other, and the outer side of the spring 21 seated in the recess portion 31c may be configured to contact the inner side surface of the retainer 11.

The retainer 11 may be coupled to the abutment 31a while the spring 21 is seated in the recess portion 31c of the abutment 31a, and it may be configured that due to the elastic force of the spring 21 the retainer 11 may be stably coupled to the abutment 31a and at the same time be easily dropped out therefrom. In addition, since different angles may be configured according to the position of the attached teeth due to the deflectable spring 21, it may be possible to prevent a feeling of foreign objects on the attached teeth.

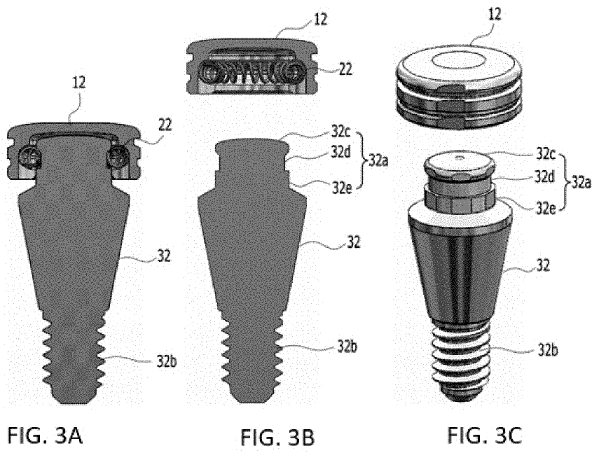

FIGS. 3A-3C are an exemplary view for explaining the configuration of an implant structure according to another embodiment of the present invention in which FIG. 3A is a sectional view, FIG. 3B is a sectional view in which a retainer is separated from a fixing portion, and FIG. 3C is an exploded perspective view. Description of the same configurations as in FIG. 1A will be omitted.

The fixing portion 32 may be formed by integrally forming an upper abutment 32a and a lower fixture 32b, wherein the abutment 32a may include a contact portion 32d with which a spring 22 disposed on the seating portion 12a of the retainer 12 is in contact, and a first protrusion portion 32c and a second protrusion portion 32e protruding outwards therefrom.

The inside of the spring 22 may contact the contact portion 32d, the first protrusion portion 32c, and the second protrusion portion 32e, and the size of the cross section of the spring 22 may be greater than the length of the contact portion 32d. In addition, the upper surface of the first protrusion portion 32c and the upper surface of the inner side of the retainer 12 may be configured to contact each other, and the second protrusion portion 32e may be formed having a polygonal shape cross section so that an operator may easily rotate it.

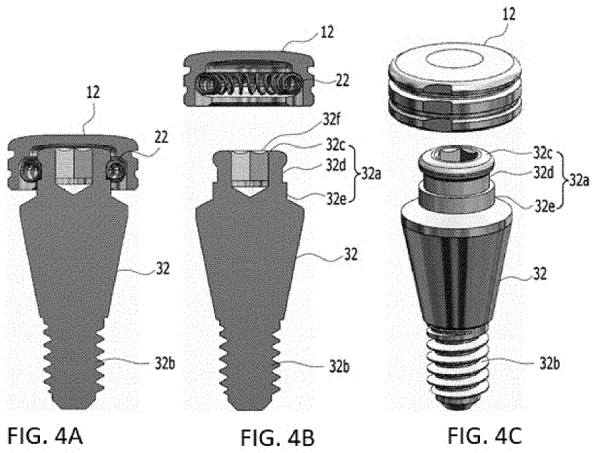

FIGS. 4A-4C are an exemplary view for explaining the configuration of an implant structure according to another embodiment of the present invention in which FIG. 4A is a sectional view, FIG. 4B is a sectional view in which a retainer is separated from a fixing portion, and FIG. 4C is an exploded perspective view. Description of the same configurations as in FIGS. 3A-3C will be omitted.

Referring to the above drawings, in an embodiment of the present invention, a tool insertion groove 32f to which the tool is fastened when implanted may be formed on the upper portion of the abutment 32a. Other configurations are the same as in FIGS. 3A-3C, and thus detailed descriptions thereof will be omitted.

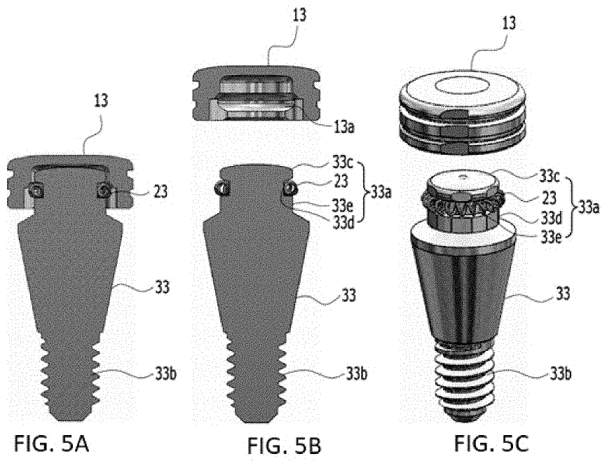

FIGS. 5A-5C are an exemplary view for explaining the configuration of an implant structure according to another embodiment of the present invention in which FIG. 5A is a sectional view, FIG. 5B is a sectional view in which a retainer is separated from a fixing portion, and FIG. 5C is an exploded perspective view.

Referring to the above drawings, the fixing portion 33 may be formed by integrally forming an upper abutment 33a and a lower fixture 33b, wherein the abutment 33a may include a contact portion 33d that a spring 23 contacts, and a first protrusion portion 33c protruding outwards therefrom and a second protrusion portion 33e protruding outwards from the lower portion thereof.

The spring 23 may be seated in the recess portion formed by the contact portion 33d, the first protrusion 33c, and the second protrusion 33e, and the upper surface of the first protrusion portion 33c may be disposed to contact the upper surface of the inner side of the retainer 13. In this embodiment, the cross section of the spring 23 may be configured to be substantially the same as the length of the contact portion 33d.

The spring 23 seated in the recess portion may be in contact with the inner side of the retainer 13.

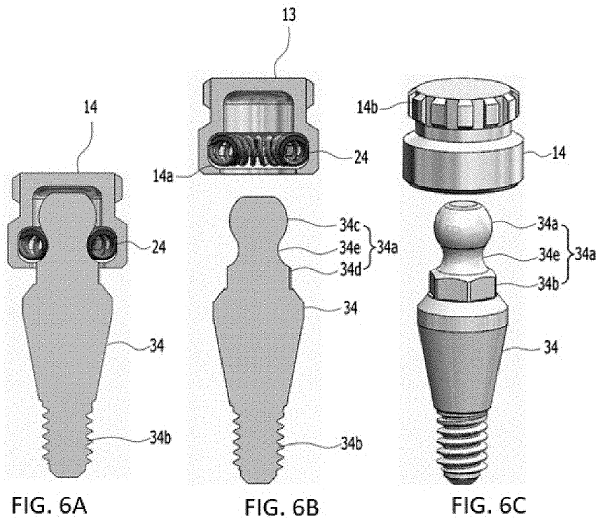

FIGS. 6A-6C are an exemplary view for explaining the configuration of an implant structure according to another embodiment of the present invention in which FIG. 6A is a sectional view, FIG. 6B is a sectional view in which a retainer is separated from a fixing portion, and FIG. 6C is an exploded perspective view.

As shown in the drawings, the fixing portion 34 may be formed by integrally forming an abutment 34a and a lower fixture 34b, wherein the abutment 34a may include an upper portion 34c rotatably formed in a spherical shape inside the retainer 14 and a lower portion 34d connecting the upper portion 34c to the body of the fixing portion 34.

The retainer 14 may have a seating portion 14a on which the spring 24 is seated therein, and an uneven portion 14b outside thereof for an operator to easily rotate it.

A bent portion 34e which the inner side of the spring 24 contacts may be formed between the upper portion 34c and the lower portion 34d of the abutment 34a so that the bent portion 34e and the spring 24 may contact when the abutment 34a is inserted into the retainer 14.

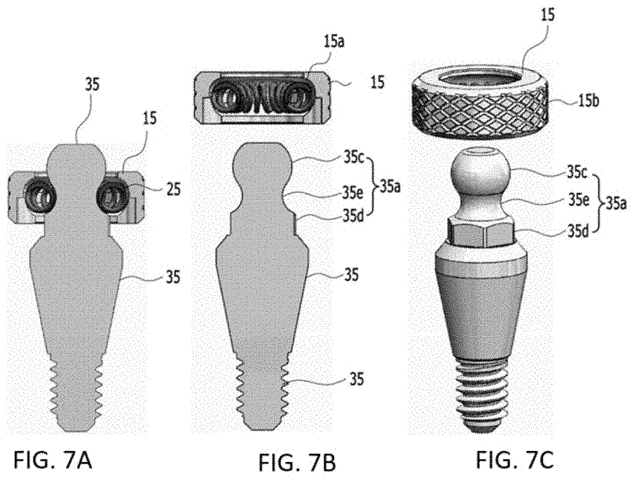

FIGS. 7A-7C are an exemplary view for explaining the configuration of an implant structure according to another embodiment of the present invention in which FIG. 7A is a sectional view, FIG. 7B is a sectional view in which a retainer is separated from a fixing portion, and FIG. 7C is an exploded perspective view, which is the same as the embodiment of FIGS. 6A-6C except for the configuration of the retainer 15.

Referring to the above drawings, the retainer 15 may be formed in a hollow cylindrical shape, and have a seating portion 15a on which the spring 25 is seated therein and an uneven portion 15b outside thereof for an operator to easily rotate it.

It may be configured that when the retainer 15 is coupled to the abutment 35a, the upper portion 35c of the abutment 35a protrudes outwards the retainer 15.

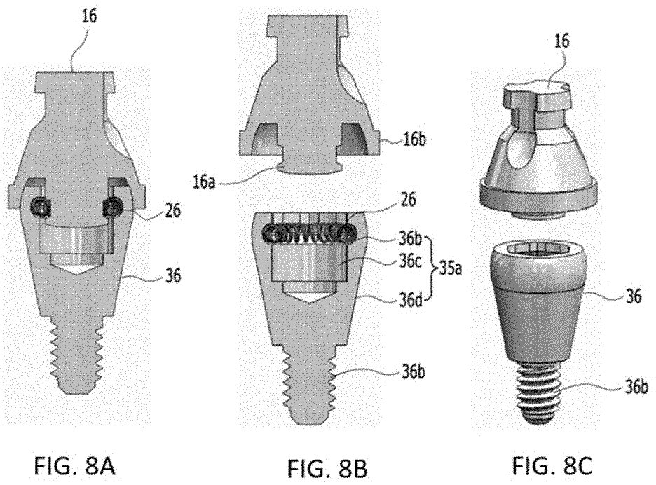

FIGS. 8A-8C are an exemplary view for explaining the configuration of an implant structure according to another embodiment of the present invention in which FIG. 8A is a sectional view, FIG. 8B is a sectional view in which a retainer is separated from a fixing portion, and FIG. 8C is an exploded perspective view. An embodiment of FIGS. 8A-8C shows an example in which a spring is seated on an abutment.

As shown in the drawings, the fixing portion 36 may be formed by integrally forming an abutment 36a and a lower fixture 36b, and in an embodiment of the present invention, the retainer 16 may have a protrusion portion 16a coupled to a fastening groove 36d of the abutment 36a and a seating portion 36c on which the spring 26 is seated, on the upper portion of the fastening groove 36d. In addition, a fastening portion 16b disposed to surround the outer surface of the abutment 36a may be formed on the outer surface of the retainer 16. The upper portion of the retainer 16 may be formed in various shapes so that an operator can easily rotate it.

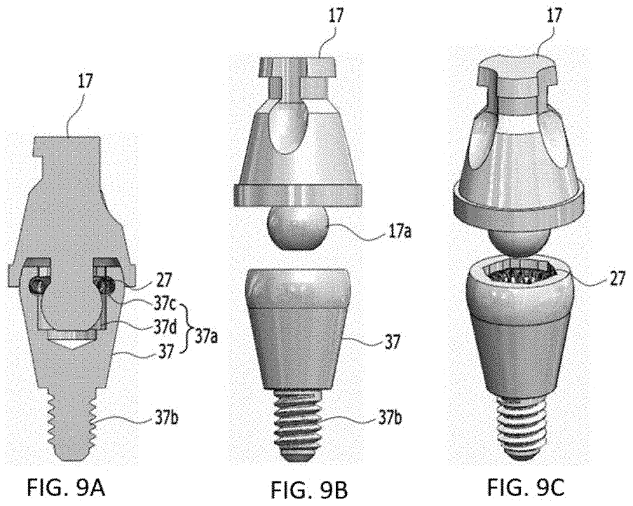

FIGS. 9A-9C are an exemplary view for explaining the configuration of an implant structure according to another embodiment of the present invention in which FIG. 9A is a sectional view, FIG. 9B is a sectional view in which a retainer is separated from a fixing portion, and 9C is an exploded perspective view. An embodiment of FIGS. 9A-9C shows an example in which a spring is seated on an abutment, as in the embodiment of FIGS. 8A-8C.

Referring to the above drawings, the fixing portion 37 may be formed by integrally forming an abutment 37a and a lower fixture 37b, and in an embodiment of the present invention, the retainer 17 may have a protrusion portion 17a coupled to a fastening groove 37d of the abutment 37a and a seating portion 37c on which the spring 27 is seated, on the upper portion of the fastening groove 37d. In an embodiment of the present invention, the protrusion portion 17a may have a spherical shape to facilitate rotation.

Meanwhile, in the description of an embodiment of the present invention, a configuration in which a single spring is formed alone has been discussed, but the present invention is not limited thereto, and a plurality of springs may be disposed to further increase the pressure.

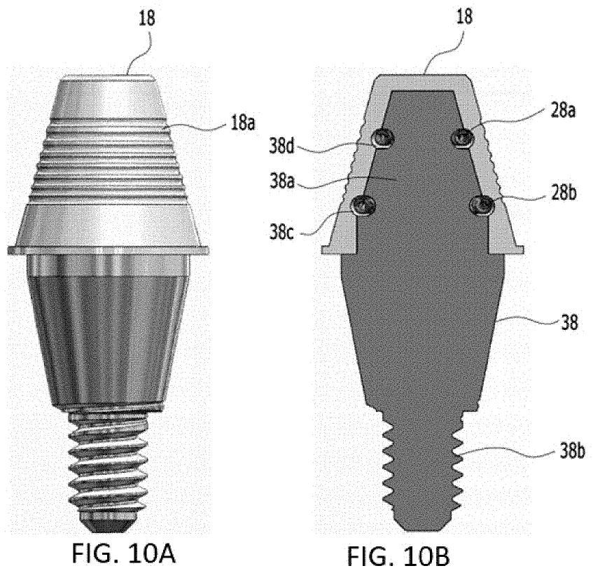

FIGS. 10A-10B is an exemplary view for explaining the configuration of an implant structure according to another embodiment of the present invention in which FIG. 10A is a front view of the implant structure according to an embodiment of the present invention and FIG. 10B is a sectional view.

Referring to the above drawings, the fixing portion 38 may be formed by integrally forming an abutment 38a and a lower fixture 38b, and in an embodiment of the present invention, an uneven portion 18a may be formed on the outer surface of the retainer 18 so that an operator can easily rotate it.

In addition, the abutment 38a of the present invention may have a first seating portion 38d and a second seating portion 38c on which a first spring 28a and a second spring 28b are seated.

With such a configuration, an implant structure in which pressure is further strengthened by a plurality of springs may be provided.

In an embodiment of the present invention, various shapes of a retainer are introduced, but a retainer having another shape configured in a shape capable of seating the spring of the present invention may be applied by an embodiment of the present invention. In addition, in an embodiment of the present invention, abutments having various shapes have been introduced, but various shapes of abutments capable of seating a spring in combination with a retainer may be applied.

In addition, in an embodiment of the present invention, A configuration in which one or two springs are seated on the retainer or abutment is described, but the present invention is not limited thereto, and it will be possible that a plurality of springs may be seated on the retainer or abutment.

As described above, as a spring is interposed between a retainer and an abutment, it may be configured that due to the elastic force of the spring the retainer may be stably coupled to the abutment and at the same time be easily dropped out therefrom. In addition, since different angles may be configured according to the position of the attached teeth due to the deflectable spring, it may be possible to prevent a feeling of foreign objects on the attached teeth.

While this invention has been described in connection with what is presently considered to be practical exemplary embodiments, those skilled in the art may understand that the invention is not limited to the disclosed embodiments, but, on the contrary, is intended to cover various modifications and equivalent arrangements included within the spirit and scope of the appended claims. Accordingly, the scope of the present invention shall be determined only according to the attached claims.

1. An implant structure, comprising:
a retainer fixing a denture structure by combining with the denture structure;
a fixing portion comprising a fixture implanted in an alveolar bone of a gum, and an abutment at an upper portion of the fixture, the abutment connecting the fixture to the retainer, wherein the abutment is integrally formed with the fixture; and
a canted ring-shaped coil spring to provide elastic force to the retainer and the abutment,
wherein a seating portion on which the spring is seated is formed inside the retainer,
wherein the coil spring is independently deflected to compensate for contact between the retainer and the abutment and surface fluctuations so that angles of the retainer and the abutment are configured differently according to a position of the denture structure, and
wherein the coil spring forms a radial or axial force for a uniform load around the spring radius, and the angle represents a movement of 1 to 40 degrees.

2. The implant structure of claim 1, wherein a first protrusion portion is formed on an upper portion of the abutment so that an inner side of the coil spring is in contact with the abutment at a lower portion of the first protrusion portion.

3. The implant structure of claim 1, wherein a recess portion in which the coil spring is seated is formed at an upper portion of the abutment, and an outer side of the coil spring is in contact with an inner side surface of the retainer.

4. The implant structure of claim 1, wherein the abutment comprises a contact portion with which the coil spring is in contact; a second protrusion portion protruding outwards from the contact portion at an upper portion of the contact portion; and a third protrusion portion protruding outwards from the contact portion at a lower portion of the contact portion,
wherein the inner side of the coil spring is in contact with the contact portion, the second protrusion portion, and the third protrusion portion.

5. The implant structure of claim 4, wherein a cross section of the coil spring is greater than a length of the contact portion and is seated on the seating portion.

6. The implant structure of claim 4, wherein the coil spring is seated in a recess portion formed by the contact portion, the second protrusion portion, and the third protrusion portion.

7. The implant structure of claim 1, wherein the abutment comprises an upper portion rotatably formed in a spherical shape; a lower portion connecting the upper portion to a body of the fixing portion; and a bent portion in which the coil spring is disposed between the upper portion and the lower portion,
wherein the inner side of the coil spring is in contact with the bent portion.

8. The implant structure of claim 7, wherein the retainer has a hollow cylindrical shape, and a portion of the upper portion protrudes outwards from the retainer.

9. The implant structure of claim 1, wherein a base material of the spring comprises any one or more of copper alloys, stainless steel alloys or titanium, and can be surface-treated.

10. (canceled)
